(19) United States
(12) Patent Application Publication
(10) Pub. No.: US 2006/0259803 A1
(43) Pub. Date: Nov. 16, 2006

(54) Power saver automatic learning method

(75) Inventors: Mark J. Edwards, Lexington, KY (US); John T. Writt, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/127,883

(22) Filed: May 12, 2005

(51) Int. Cl. G06F 1/32

(52) U.S. Cl. 713/320

(57) ABSTRACT

A method of operating an electronic apparatus in a power saving mode by developing at least one pattern of use of the electronic apparatus, utilizing the at least one pattern of use to develop and/or select a plurality of use profiles, and polling a user to make a selection of one use profile from the plurality of use profiles to determine when the electronic apparatus should be put in a power saving mode.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to an operating method utilized in an electronic assembly, and, more particularly, to an adaptive power saver method.

2. Description of the Related Art

Electronic devices nearly always include a switch for applying and removing power to the electronic device. Many electronic devices, such as computer peripheral devices, require a certain amount of warm-up time before they can be utilized. The turning of peripheral devices on and off manually is not a practical solution to save energy, particularly when the peripheral device is remote from a work station that may include a computer operatively connected to the peripheral device. It is known to utilize a low or no-power state, often called a power-saver mode, which is effected after a period of non-use of the device.

Today's users of electronic devices, such as copiers, printers and multi-functional devices, have conflicting desires regarding the power state of the machine. Users want the machine to be in a state ready to copy, print or scan, but at all other times users would prefer the machine to be in a lower power state for power cost and environmental reasons. The United States Government has mandated power saving states for electronics through initiatives, such the ENERGY STAR® program administered by the Environment Protection Agency. A typical electronic device will “wake-up” upon a first job request and then stay in a ready mode for some time out period and then return to a low power mode. It is not an unusual experience for the user to have to wait for the electronic device to warm-up before executing the requested task.

What is needed in the art is an intelligent, adaptive method for placing an electronic device into a power saving mode.

### SUMMARY OF THE INVENTION

The present invention provides a method for adaptively entering an electronic device into a power saver mode.

The invention comprises, a method of operating an electronic apparatus including the steps of developing at least one pattern of use of the electronic apparatus; utilizing the at least one pattern of use to develop or select a plurality of use profiles; and polling a user to make a selection from one of the plurality of use profiles to determine when the electronic apparatus should be put into a power save mode.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system that utilizes the methods of the present invention;

FIG. 2 is a flow chart depicting a method of adapting a power save use profile in accordance with an embodiment of the method of the present invention;

FIG. 3 is a flow chart depicting another embodiment of the present invention for the selection of a power saver use profile;

FIG. 4 is a flow chart depicting another embodiment of a method of the present invention;

FIG. 5 is a flow chart that further illustrates the power saver method depicted in FIG. 4; and

FIG. 6 is a flow chart that also further illustrates the power saver method depicted in FIG. 4.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

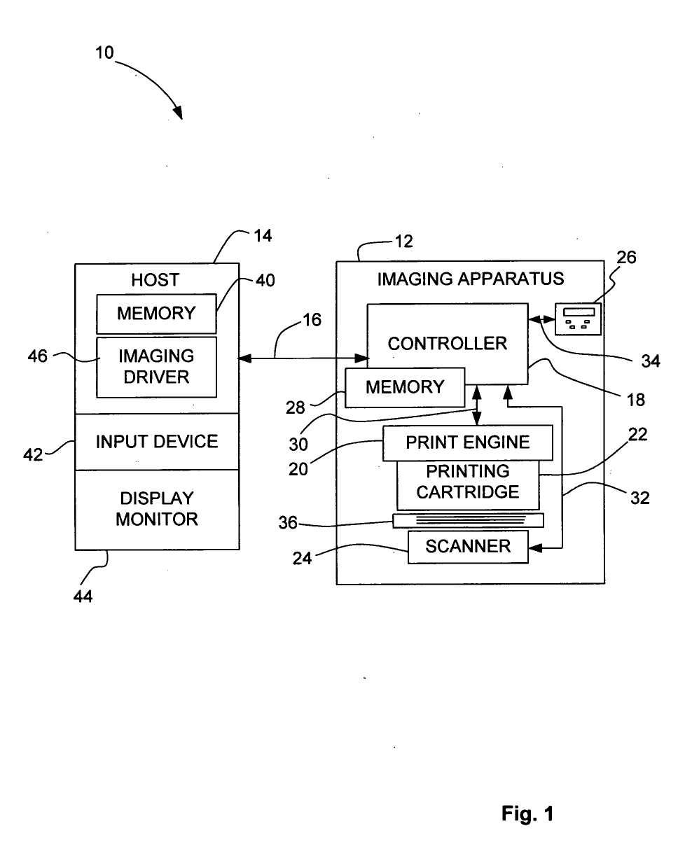

Referring now to the drawings, and more particularly to FIG. 1, there is shown a diagrammatic depiction of an imaging system 10 that utilizes the method of the present invention. Imaging system 10 includes an imaging apparatus 12 and a host 14, each of which are an electronic apparatus. Imaging apparatus 12 communicates with host 14 by way of communication link 16. As used herein, the term “communications link” is used to generally refer to a structure that facilitates electronic communication between two components, and may operate using wired or wireless technology.

Imaging apparatus 12 can be, for example, an inkjet printer, an electrophotographic printer, a copier, a thermal transfer printer or a multi-functional device (MFD) that includes a print engine, a scanner and possibly a fax unit. For example, as shown in FIG. 1, imaging apparatus 12 includes a controller 18, a print engine 20, a printing cartridge 22, a scanner 24 and a user interface 26. Imaging apparatus 12 may communicate with host 14 by way of a standard communication protocol, such as for example, universal serial bus (USB) or Ethernet.

Controller 18 includes a processor unit and associated memory 28. Controller 18 communicates with print engine 20 by way of communication link 30. Controller 18 communicates with scanner 24 by way of communications link 32. User interface 26 is communicatively coupled to controller 18 by way of communication link 34. Controller 18 serves to process print data and to operate print engine 20 during printing, as well as to operate scanner 24 and process image data obtained by way of scanner 24.

In the context of the examples for imaging apparatus 12 described herein, print engine 20 can be, for example, an inkjet print engine, an electrophotographic print engine or a thermal transfer engine, configured for forming an image on a substrate 36, such as a sheet of paper, transparency or fabric. Print engine 20 operates on printing cartridge 22 to form text and images on substrate 36.

Scanner 24 may be in the form of a sheet feed or flatbed scanner. As is known in the art, a sheet feed scanner transports a sheet to be scanned past a stationary sensor device. In a flatbed scanner, the sheet or object to be scanned is held stationary, and a scanning bar including a sensor is scanned over the stationary sheet or object.

Host 14, which may be optional, may be, for example, a personal computer including memory 40, an input device 42, such as a keyboard, and a display monitor 44. Host 14 further includes a processor, input/output interfaces and at least one mass data storage device such as a hard drive, CD Rom or a DVD unit.

Host 14 includes in memory 40 a software program including program instructions that function as an imaging driver 46 for imaging apparatus 12. Imaging driver 46 is in communication with controller 18 of imaging apparatus 12 by way of communication link 16. Imaging driver 46 facilitates communication between imaging apparatus 12 and host 14 and may provide formatted print data to imaging apparatus 12, and more particularly, to print engine 20 to print an image or text.

The present invention uses a combination of usage data and user feedback so that the imaging apparatus 12 and/or host 14 can determine the optimal times of entering a power saver mode and a ready mode. Although the present invention may operate in either imaging apparatus 12 or host 14, or as a combination of imaging apparatus 12 and host 14, for simplicity of understanding, the present invention will be presented as being a method that operates in imaging apparatus 12 and may send and receive information to/from host 14. Imaging apparatus 12 includes an algorithm that utilizes the present invention to gather usage experience and polling of the user to determine the best time to be in a power saver mode. There are several different implementations of the present invention which are summarized herein. There are three main inputs into the power saver artificial intelligence (AI): those being user setup information, user polling response and current usage, along with current date and time information available from imaging apparatus 12. User setup information consists of data entered by the user that is related to intended usage patterns of imaging apparatus 12. User polling response is data obtained by polling the user on host 14 or on imaging apparatus by way of user interface 26 before, during or after an operation is performed on imaging apparatus 12. Current usage information is obtained from the current operations that are being performed. The specific combinations of the three inputs that are used by the specific embodiments are described hereinbelow. The power saver AI stores these inputs and the decisions made from these inputs in memory as needed. In addition, the power saver AI uses these inputs along with data in the memory to determine if the device should be in a power saver mode or in a ready mode.

One embodiment uses the current usage input to determine the power mode. The device learns usage patterns and then determines when to be in a power saver or power ready mode based on these patterns. The usage patterns can be classified as absolute or relative. The absolute pattern makes reference to specific days and/or time. For example, if usage is determined to be considerably higher on Monday through Friday from 8:00 am to 5:00 pm, the device is in a ready mode during that time on those days. A relative pattern is based upon time relative to an initial operation of the device. For example, if usage is determined to be usually grouped within a two hour time-span, the device would stay in a ready mode for two hours after an initial operation.

Another embodiment is a user setup embodiment in which setup information is entered by the user in the use profile; the information that is entered reflects what a user decides best fits the user's situation. This can be done by way of interaction with the driver or a dialogue upon the first installation of imaging apparatus 12 to host 14 or when requested by the user. Such a profile relies upon the absolute and/or relative patterns, as discussed above. The power saver AI stores this profile in memory and based upon the current date/time (or time elapsed since initial usage if a relative profile) the appropriate power mode is then selected so as to put imaging apparatus 12 in a power saver mode or a ready mode.

Yet another embodiment of the present invention utilizes polling and current usage inputs to determine the power mode. Statistical observation, similar to a previous embodiment, is performed to determine usage patterns. After a certain number of operations have been performed, the user is polled to select a possible profile that matches the device usage by the user. The power saver AI selects a few of the profiles that are possible, based upon the match obtained from gathering usage data. The user has the opportunity to select one of these profiles, and that profile is then used by the power saver AI to determine the power mode timing.

Another embodiment uses statistical and polling information that is initially input by a user into an “initial profile.” The user enters information into the initial profile, statistical observation of usage patterns is performed, and the user is polled and given the option to switch to a different profile, when such a profile is determined by the power saver AI to optimize the power usage of imaging apparatus 12.

A further embodiment of the present invention uses polling and current usage inputs to determine the power mode. After an initial operation, the user is polled to determine intended future use of the device. One of at least two types of polling can occur. The first type simply asks if continued usage is planned and a YES or NO answer is received. If YES, imaging apparatus 12 stays in a ready mode for a predetermined period of time (such as 4 hours or 8 hours). If the answer is NO, imaging apparatus 12 enters power saver mode either immediately or in a short amount of time, such as 5 minutes. The second type of polling asks the user the expected length of time of continued usage of imaging apparatus 12. This is done with suggested amounts of time, such as 15 minutes, 30 minutes, 1 hour, 4 hours or 8 hours; or it can accept a numeric entry from the user to represent the expected length of usage of imaging apparatus 12. The power saver AI then keeps the device in ready mode for that length of time.

Still yet another embodiment of the present invention has a statistical aspect in combination with polling when a usage anomaly occurs. This implementation uses statistical techniques and an initial use profile, each of which are discussed above. Usage is observed, patterns are determined and the power saver AI selects a power mode based upon these patterns. However, if an operation occurs outside of a normal usage pattern, the user is polled to determine intended future usage. Such a polling can be of the YES/NO or length of time polling implementation described above. Further, this implementation can incorporate an initial intended usage profile setup.

It is not desirable to annoy a user with unnecessary polling on monitor 44 or user interface 26. As such, every polling operation can include the option to never be polled again, or to not be polled for a predetermined period of time, for example, for the rest of the day. In addition, polling can be timed out, such that after a reasonable period of time a default selection is made if the user does not respond to the polling. A diminishing timer bar can be displayed on display monitor 44 and/or user interface 26 to indicate the remaining amount of time to respond to the poll. For both polling and setup, the user can be notified that the reason for being asked about an intended usage is to save power, and to have the device ready when needed. The data gathering portion of the methods described herein can employ a mechanism to systematically remove older data, for instance keeping only the last three weeks of usage data. Further it is contemplated that statistical methods including data confidence methods can be utilized by the power saver AI for the selection of use profiles.

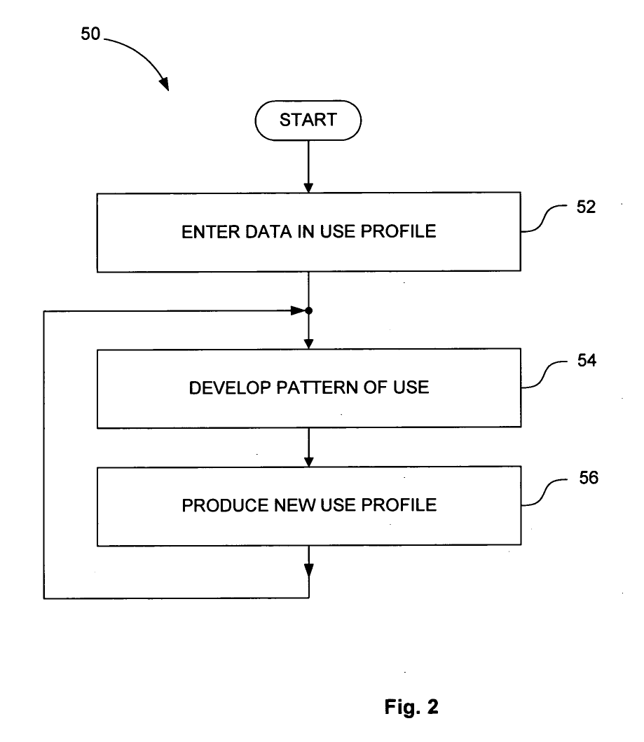

Now, additionally referring to FIG. 2 there is shown an embodiment of the present invention identified as method 50. At step 52, the user is requested to enter data, by way of, for example, input device 42, which will reflect an intended use profile of imaging apparatus 12. The use profile may include dates and times of each day of the week in which use of imaging apparatus 12 is anticipated. Further, the use profile can include anticipated periods of utilization of imaging apparatus 12 after an initial use of imaging apparatus 12. Step 52 is optional and method 50 may automatically execute without the entry of information by the user. At step 54, power saver AI gathers data in the form of patterns of use of imaging apparatus 12. Patterns of use may include usage rates during specific days of the week as well as specific times of the day. The data may include incidence of use as well as duration of use of imaging apparatus 12. The power saver AI utilizes the pattern of use to produce new use profiles at step 56. Alternatively, power saver AI can develop a use profile to replace the use profile entered at step 52, without further input from the user. The new use profile is utilized by imaging apparatus 12 to determine when imaging apparatus 12 will enter a power saver mode or a ready mode. Evaluation of the pattern of use is ongoing so that after completing step 56 method 50 returns to step 54 to continue the development of patterns of use, which may lead to a new use profile to be developed and implemented by power saver AI.

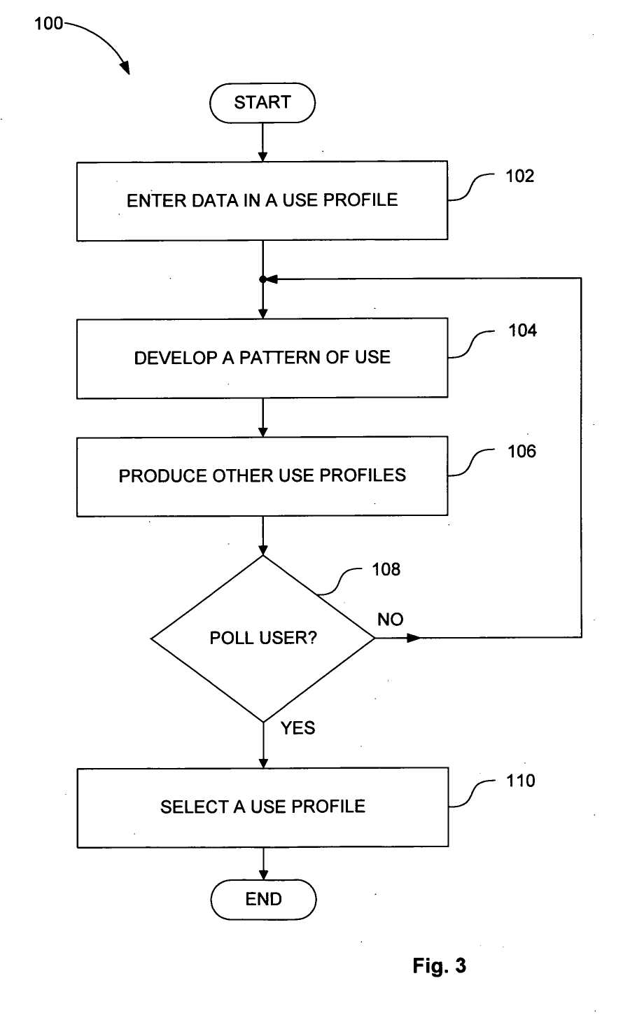

Now, additionally referring to FIG. 3 there is shown a method 100, which is an alternative to method 50. Step 102 is substantially similar to step 52. Step 104 is substantially similar to step 54. At step 106 power saver AI produces several use profiles in addition to the use profile input by the user at step 102. Power saver AI then determines at step 108 whether the use profiles produced at step 106 provide sufficient advantages over a use profile currently being used, that the user should be polled. If it is determined at step 108 not to poll the user, then method 100 returns to step 104. If power saver AI determines at step 108 that another use profile may be advantageous over the current use profile, the user is requested to select a new use profile at step 110. The user may be presented several use profiles from which to choose, including the use profile entered at step 102. After the user selects a new use profile, that use profile becomes the current use profile. After completing the selection of a new use profile at step 110, method 100 ends. Alternatively, method 100 could resume at step 104.

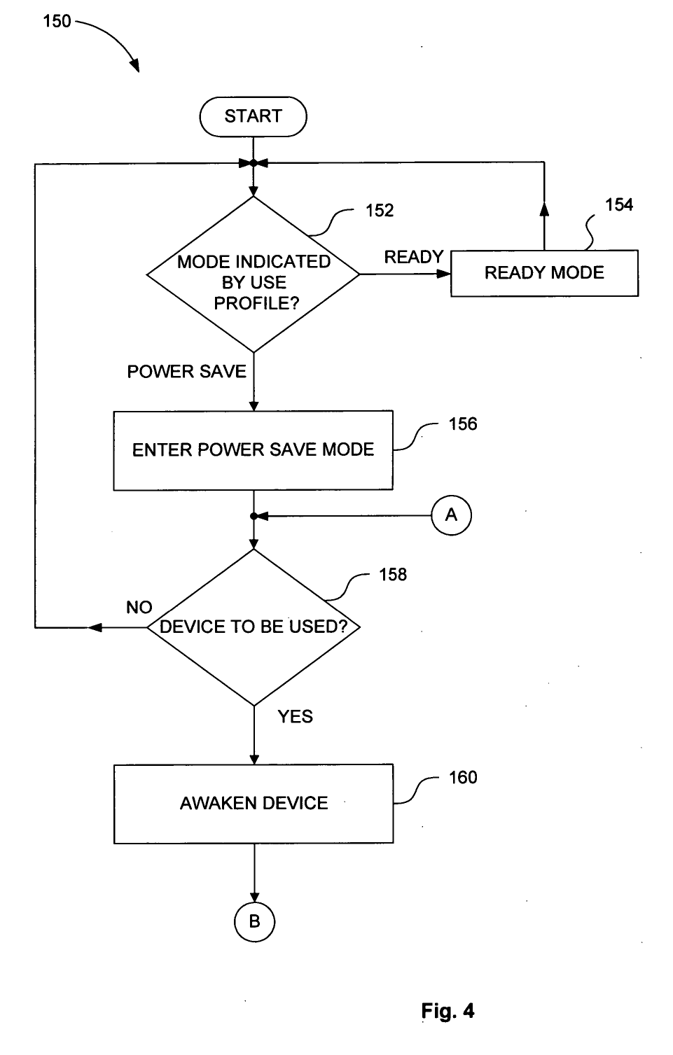

Now, additionally referring to FIG. 4 there is shown another embodiment of the method of the present invention identified as method 150. At step 152, it is determined whether imaging apparatus 12 should be in a ready mode or a power save mode as indicated by the current use profile. If the current use profile determines that imaging apparatus 12 should be in a ready mode based upon the current date and time, then method 150 causes imaging apparatus 12 to go into ready mode at step 154 even if imaging apparatus 12 is not being requested to perform any task. At step 154, imaging apparatus 12 is placed in the ready mode and the method proceeds back to step 152 to await any change in the mode as indicated by the use profile.

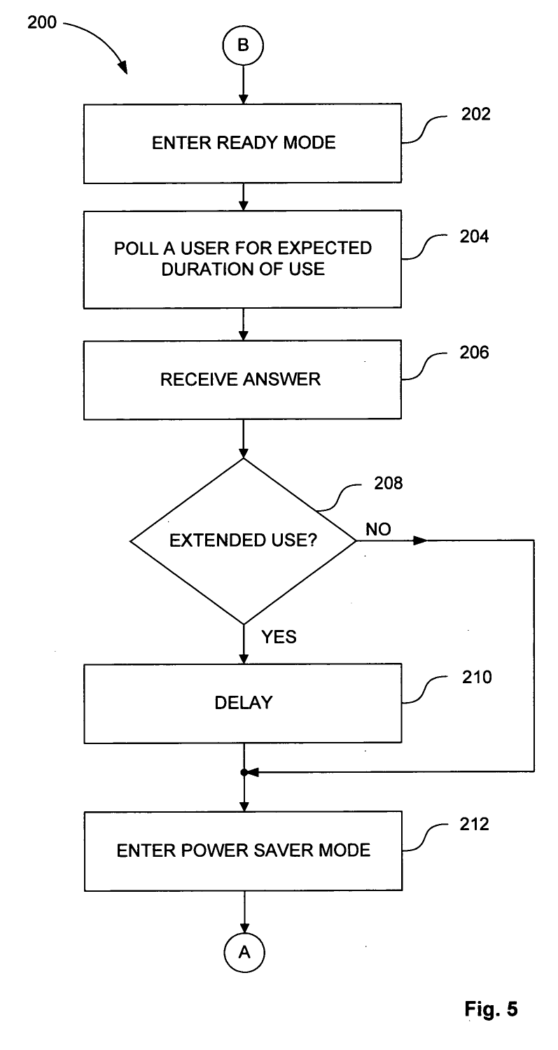

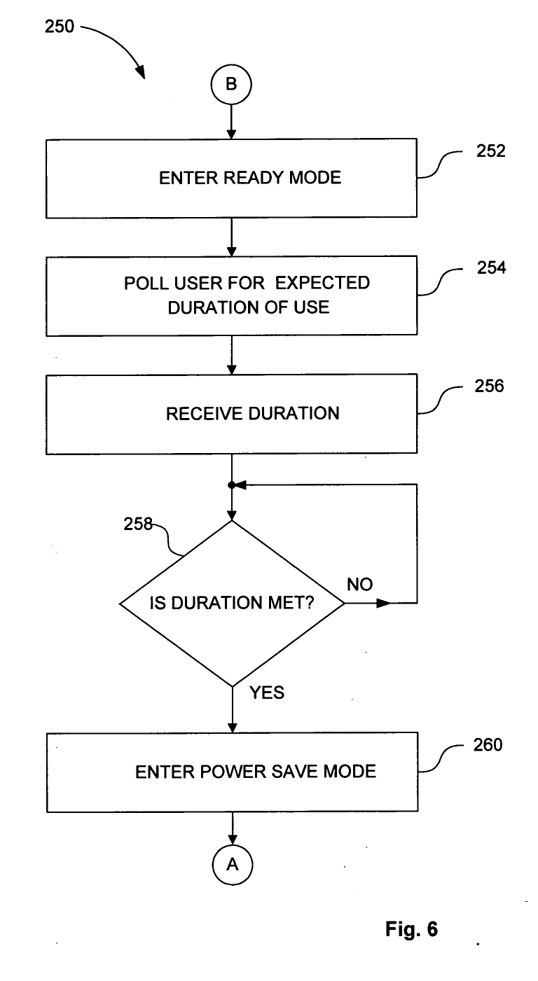

If at step 152, it is determined that imaging apparatus 12 should be placed in a power save mode, method 150 proceeds to step 156 and imaging apparatus 12 is placed into a power save mode. The power save mode causes reduced power consumption by imaging apparatus 12 by turning off portions of imaging apparatus 12 such as heating elements, lights and/or displays. At step 158, it is decided whether imaging apparatus 12 is needed for use. If no use of imaging apparatus 12 is required, indicated, for example, by no recent receipt of data, the decision causes method 150 to return to step 152. If at step 158 it is determined that imaging apparatus 12 is needed for use, then imaging apparatus 12 is awakened at step 160 and method 150 proceeds to point B, which may continue to point B of method 200 depicted in FIG. 5 or to point B of method 250 depicted in FIG. 6.

Now, additionally referring to FIGS. 5 and 6, there are shown methods 200 and 250, each of which may interface with method 150. First, referring to method 200 imaging apparatus 12 is enters a ready mode at step 202, by supplying power to portions of imaging apparatus 12 that have been previously powered-down or powered-off. The awakening procedures may include time delays until portions of imaging apparatus 12 are in a proper logical state or have been heated or cooled to proper temperatures. Method 200 then continues to step 204, which can be executed while imaging apparatus 12 is awakening from power save mode. At step 204 a user is polled to determine the expected duration of use of imaging apparatus 12. This is a request to a user who needs to use imaging apparatus 12 during a time in which the current use profile would normally have placed imaging apparatus 12 in a power save mode. An answer is received from the user at step 206. The answer from the user may be a YES or NO answer so that at step 208 if there is not going to be any extended use then imaging apparatus 12 will return to a power save mode by continuing to step 212 after imaging apparatus 12 has completed its task. If the answer received at step 206 indicates an extended use, then method 200 is delayed at step 210 for a predetermined time, such as 2 hours, 4 hours or 8 hours. After the expiration of the predetermined time, method 200 proceeds to step 212 and imaging apparatus 12 is placed into a power save mode. Method 200 then proceeds to point A, which interconnects with point A of method 150.

Now, additionally referring to FIG. 6 there is shown another embodiment of the present invention in the form of a method 250 which is similar to method 200. In this implementation point B of method 150 interconnects at point B of method 250. At step 252, imaging apparatus 12 awakens from a power save mode and enters a ready mode, which is substantially similar to step 202. Likewise, step 254 is similar to step 204, except that a duration of expected use of imaging apparatus 12 is requested. This may be in the form of a list of predetermined durations, one of which is selected by the user; or a user may enter a numeric value representing a duration of the expected use of imaging apparatus 12. At step 256, the expected duration of use of imaging apparatus 12 is obtained from the user and imaging apparatus 12 is kept in a ready mode by way of step 258 until the duration entered for extended use is met. When the duration is met, imaging apparatus 12 enters a power save mode at step 260, and method 250 ends at point A and goes to point A of method 150.

As way of illustration, patterns of usage may be gathered for periods of pre-selected times such as illustrated in the following table where the numbers in the day of the week rows indicate the number of jobs performed by the device within the two hour time period:

| | AM | | | | | | PM | | | | | |
|---|---|---|---|---|---|---|---|---|---|---|---|---|
| | From-To | | | | | | | | | | | |
| | 12-2 | 2-4 | 4-6 | 6-8 | 8-10 | 10-12 | 12-2 | 2-4 | 4-6 | 6-8 | 8-10 | 10-12 |
| Mon. | 0 | 0 | 0 | 0 | 2 | 1 | 0 | 3 | 1 | 0 | 0 | 0 |
| Tues. | 0 | 0 | 0 | 0 | 1 | 1 | 0 | 1 | 1 | 1 | 0 | 0 |
| Wed. | 0 | 0 | 0 | 0 | 0 | 0 | 1 | 2 | 0 | 0 | 0 | 0 |
| Thur. | 0 | 0 | 0 | 0 | 0 | 1 | 0 | 1 | 1 | 0 | 0 | 0 |
| Fri. | 0 | 0 | 0 | 0 | 1 | 0 | 4 | 3 | 3 | 1 | 0 | 0 |
| Sat. | 0 | 0 | 0 | 0 | 0 | 0 | 0 | 0 | 0 | 0 | 0 | 0 |
| Sun. | 0 | 0 | 0 | 0 | 0 | 0 | 0 | 0 | 0 | 0 | 0 | 0 |

In the forgoing table the number of uses of imaging apparatus 12 is determined for pre-selected two hour time periods. The power saver AI can use this pattern of use to predict the times of usage of imaging apparatus 12. For example for a given day of the week imaging apparatus 12 may be turned on for each two hour period, which is supported by this pattern of use. For example, on a Monday, imaging apparatus 12 is placed in a ready mode at 8 a.m. and at noon it is put into power saver mode. At 2 p.m. it is put into ready mode until 6 p.m., when it is returned to power saver mode. Further, the frequency of use can be used to determine when imaging apparatus 12 is placed in a ready mode. For example, time periods in which the usage is at least 2 would cause imaging apparatus 12 to be in a ready mode and for all other time periods imaging apparatus 12 would be in a power save mode. This would require a user that used imaging apparatus 12 during a low use period to wait until imaging apparatus 12 was ready to function.

In another embodiment, the power saver AI can determine how often two or more contiguous two-hour time periods have usage activity. If frequent usage is determined, such as the number of uses exceeds a predetermined value, then a relative power ready mode pattern may be applied. For instance, if a job were performed at 10 A.M. on Saturday with no other historical usage data, the machine may be placed in a relative power ready pattern for 2 hours after this job. Also usage data for a prior week or multiple weeks may be accumulated to determine usage patterns. Further, systematic removal of older data may be used to track current usage patterns, for instance keeping only the prior two weeks worth of usage data.

Advantageously the present invention is adaptive in determining the use profile of imaging apparatus 12, which is utilized to reduce the energy usage of imaging apparatus 12. While described as reducing the power of imaging apparatus 12, the present invention can also be utilized on host 14 or portions of host 14, such as display monitor 44.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of operating an electronic apparatus, comprising:
developing at least one pattern of use of the electronic apparatus;
utilizing said at least one pattern of use to one of develop and select a plurality of use profiles; and
polling a user to make a selection of one use profile from said plurality of use profiles to determine when the electronic apparatus should be put in a power save mode.

2. The method of claim 1, further comprising placing the electronic apparatus in a power save mode dependent on said selection.

3. The method of claim 2, further comprising entering an initial use profile that is used to determine when said placing step is executed.

4. The method of claim 3, wherein said initial use profile is included in said plurality of use profiles and is presented to the user in said polling step.

5. The method of claim 1, wherein said polling is carried out after at least one of a predetermined number of uses of the electronic apparatus and a predetermined statistical confidence level is achieved.

6. The method of claim 1, wherein said plurality of profiles each include at least one of specific days, specific times of a day and time spans from an initial use of the electronic apparatus.

7. The method of claim 1, wherein the electronic apparatus is interfaced with a computer, the method being executed on at least one of the electronic apparatus and said computer.

8. The method of claim 1, wherein the electronic apparatus is one of a printer, a multifunction device, a scanner, and a copier.

9. The method of claim 1, wherein said utilizing includes using a statistical algorithm to develop said plurality of use profiles.

10. The method of claim 1, wherein said polling includes timing out said polling step if the user does not make a selection.

11. The method of claim 1, wherein said polling includes allowing the user to select an option of not being polled in the future.

12. The method of claim 1, further comprising comparing said plurality of use profiles to a current use profile and deferring said polling unless at least one of said plurality of use profiles is statistically superior to said current use profile.

13. A method of controlling electrical energy use in an electronic apparatus, comprising:
awaking from a power save mode;
polling a user of the electronic apparatus at least one of during said awaking and after said awaking; and
returning to said power save mode after a predetermined time dependent on an answer received from the user in said polling.

14. The method of claim 13, wherein said polling takes place only once after said awaking step.

15. The method of claim 13, wherein said answer includes one of a “YES” and a “No” to an inquiry as to whether the electronic apparatus will be used for an extended time.

16. The method of claim 15, wherein said predetermined time is set to be at least 4 hours if said answer is “YES”.

17. The method of claim 15, wherein said predetermined time is set to be less than 5 minutes if said answer is “No”.

18. The method of claim 13, wherein said answer includes one of a specified time and a selected time to an inquiry as to how long the electronic apparatus will be used.

19. The method of claim 18, wherein said predetermined time is set to one of said specified time and said selected time.

20. The method of claim 18, wherein said specified time includes a time duration in the form of a numeric entry representing at least one of minutes and hours, and said selected time including a selection from a set of predetermined durations.

21. The method of claim 13, wherein said polling includes timing out said polling if the user does not make a selection.

22. The method of claim 13, wherein said polling includes allowing the user to select an option of not being polled in the future.

23. A method of controlling the use of electrical energy in an electronic apparatus, comprising:
developing at least one pattern of use of the electronic apparatus;
utilizing said at least one pattern of use to develop a use profile; and
placing the electronic apparatus in one of a power save mode and a ready mode depending on said use profile.

24. The method of claim 23, further comprising using said use profile to determine when said placing is executed.

25. The method of claim 23, further comprising awakening the electronic apparatus from said power save mode when the electronic apparatus is requested to perform an operation.

26. The method of claim 23, further comprising entering data in said use profile which is used by the electronic apparatus prior to said developing step.

27. The method of claim 23, wherein said utilizing includes using a statistical algorithm to develop said use profile.

28. The method of claim 25, further comprising:
polling a user after said awakening step; and
returning to said power save mode after a predetermined time based on an answer received from the user in said polling step.

29. The method of claim 28, wherein said answer includes one of a “YES” and a “NO” to an inquiry as to whether the electronic apparatus will be used for an extended time.

30. The method of claim 29, wherein said predetermined time is set to be at least 4 hours if said answer is “YES”.

31. The method of claim 29, wherein said predetermined time is set to be less than 5 minutes if said answer is “NO”.

32. The method of claim 28, wherein said answer includes one of a specified time and a selected time to an inquiry as to how long the electronic apparatus will be used.

33. The method of claim 32, wherein said predetermined time is set to one of said specified time and said selected time.

34. The method of claim 33, wherein said specified time includes a time duration in the form of a numeric entry representing at least one of minutes and hours, and said selected time including a selection from a set of predetermined durations.
